(19) United States
(12) Patent Application Publication
(10) Pub. No.: US 2015/0109983 A1
(43) Pub. Date: Apr. 23, 2015

(54) Control Method and Apparatus for Wireless Fidelity Device in Terminal, and Terminal

(71) Applicant: Huawei Device Co., Ltd., Shenzhen (CN)

(72) Inventors: Jianchun Zhang, Shenzhen (CN); Jing Zhao, Beijing (CN)

(21) Appl. No.: 14/584,461

(22) Filed: Dec. 29, 2014

Related U.S. Application Data
(63) Continuation of application No. PCT/CN2012/087310, filed on Dec. 24, 2012.

(51) Int. Cl. H04W 52/02

(52) U.S. Cl. CPC H04W 52/0241
USPC 370/311

(57) ABSTRACT

A control method for a Wi-Fi device in a terminal, including acquiring, in a moving process of the terminal, first location information at a first moment, second location information at a second moment, and coverage of each of Wi-Fi access points corresponding to each of all Wi-Fi access point identifiers stored in the terminal; and triggering turning-off or turning-on of the Wi-Fi device according to that a location corresponding to the first location information and a location corresponding to the second location information are outside or within the coverage of each of the Wi-Fi access points corresponding to each of all the Wi-Fi access point identifiers stored in the terminal. In embodiments of the present invention, turning-off or turning-on of a Wi-Fi device in a terminal can be triggered according to location information of the terminal.

### CROSS-REFERENCE TO RELATED APPLICATIONS

This application is a continuation of International Application No. PCT/CN2012/087310, filed on Dec. 24, 2012, which is hereby incorporated by reference in its entirety.

### TECHNICAL FIELD

The present invention relates to the field of communications technologies, and in particular, to a control method and apparatus for a wireless fidelity (Wi-Fi) device, and a terminal.

### BACKGROUND

When a terminal does not use a Wi-Fi function, a Wi-Fi device for starting a Wi-Fi connection in the terminal is in a standby state, and therefore certain power is still consumed. For example, test data in a certain mobile phone indicates that if no Wi-Fi access point identifier has been stored, a current is about 5 milliamps (mA) when the screen of the mobile phone is turned off, while if a Wi-Fi access point identifier has been stored, a current is about 10 milliamps when the screen of the mobile phone is turned off.

If a Wi-Fi device in a terminal is turned off immediately after the terminal is disconnected from a Wi-Fi access point, when re-entering an area covered by the Wi-Fi access point, the Wi-Fi device cannot be automatically connected to the Wi-Fi access point.

A common problem for a Wi-Fi device is that, after leaving an area covered by a Wi-Fi access point, the Wi-Fi device enters a standby state, thereby causing an additional current consumption of 5-10 mA, and if the Wi-Fi device is turned off, when re-entering the area covered by the Wi-Fi access point, the Wi-Fi device cannot be automatically turned on.

### SUMMARY

Embodiments of the present invention provide a control method for a Wi-Fi device in a terminal, which can trigger turning-off or turning-on of the Wi-Fi device in the terminal according to location information of the terminal, so that power of the terminal is saved, and furthermore, the Wi-Fi device does not need to be turned on manually by a user.

In a first aspect, the present invention provides a control method for a Wi-Fi device in a terminal, including acquiring first location information of the terminal at a first moment, second location information of the terminal at a second moment, and coverage of each of Wi-Fi access points corresponding to each of all Wi-Fi access point identifiers stored in the terminal, where the first moment is earlier than the second moment; triggering turning-off of the Wi-Fi device when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment; and triggering turning-on of the Wi-Fi device when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment.

With reference to the first aspect, in a first possible implementation manner, the step of triggering turning-off of the Wi-Fi device when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment includes determining a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and triggering the turning-off of the Wi-Fi device when the location corresponding to the first location information is within the coverage of the at least one Wi-Fi access point among the Wi-Fi access points, and the location corresponding to the second location information is outside the coverage of each of the Wi-Fi access points corresponding to each of all the Wi-Fi access point identifiers.

With reference to the first aspect, in a second possible implementation manner, the step of triggering turning-on of the Wi-Fi device when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment includes determining a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and triggering the turning-on of the Wi-Fi device when the location corresponding to the first location information is outside the coverage of each of the Wi-Fi access points corresponding to each of all the Wi-Fi access point identifiers, and the location corresponding to the second location information is within the coverage of the at least one Wi-Fi access point among the Wi-Fi access points.

With reference to the first aspect and the first or the second possible implementation manner of the first aspect, in a third possible implementation manner, the control method further includes acquiring a trigger instruction for connecting to a new Wi-Fi access point, where the trigger instruction carries an identifier of the new Wi-Fi access point; and acquiring and associatively storing the identifier of the new Wi-Fi access point and coverage of the new Wi-Fi access point.

With reference to the first aspect and the first to the third possible implementation manners of the first aspect, in a fourth possible implementation manner, after the step of triggering turning on the Wi-Fi device, the control method further includes sending a first search instruction to the Wi-Fi device, so that the Wi-Fi device searches for each of the Wi-Fi access points corresponding to each of all the Wi-Fi access point identifiers stored in the terminal, and the Wi-Fi device establishes a connection to one of found Wi-Fi access points.

With reference to the first aspect and the first to the third possible implementation manners of the first aspect, in a fifth possible implementation manner, after the step of triggering turning on the Wi-Fi device, the control method further includes sending a second search instruction to the Wi-Fi device, so that the Wi-Fi device searches for each of the Wi-Fi access points corresponding to each of all the Wi-Fi access point identifiers stored in the terminal; receiving identifiers of found Wi-Fi access points sent by the Wi-Fi device; determining an identifier of a Wi-Fi access point to which a connection is established for the most times among the identifiers of the found Wi-Fi access points; and sending, to the Wi-Fi device, the identifier of the Wi-Fi access point to which the connection is established for the most times, so that the Wi-Fi device establishes a connection to the Wi-Fi access point corresponding to the identifier of the Wi-Fi access point to which the connection is established for the most times.

In a second aspect, the present invention provides a control apparatus, including an acquiring unit configured to acquire first location information of a terminal at a first moment, second location information of the terminal at a second moment, and coverage of each of Wi-Fi access points corresponding to each of all Wi-Fi access point identifiers stored in the terminal, where the first moment is earlier than the second moment; a first control unit configured to trigger turning-off of a Wi-Fi device when it is determined that the terminal is located within coverage, which is acquired by the acquiring unit, of at least one Wi-Fi access point among the Wi-Fi access points at the first moment, and is located outside the coverage of each of the Wi-Fi access points corresponding to each of all the Wi-Fi access point identifiers at the second moment; and a second control unit configured to trigger turning-on of the Wi-Fi device when it is determined that the terminal is located outside the coverage, which is acquired by the acquiring unit, of each of the Wi-Fi access points corresponding to each of all the Wi-Fi access point identifiers at the first moment, and is located within coverage of at least one Wi-Fi access point among the Wi-Fi access points at the second moment.

With reference to the second aspect, in a first possible implementation manner, the first control unit includes a first determining subunit and a first control subunit, where the first determining subunit is configured to determine a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and the first control subunit is configured to trigger the turning-off of the Wi-Fi device when the first determining subunit determines that the location corresponding to the first location information is within the coverage of the at least one Wi-Fi access point among the Wi-Fi access points, and the location corresponding to the second location information is outside the coverage of each of the Wi-Fi access points corresponding to each of all the Wi-Fi access point identifiers.

With reference to the second aspect, in a second possible implementation manner, the second control unit includes a second determining subunit and a second control subunit, where the second determining subunit is configured to determine a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and the second control subunit is configured to trigger the turning-on of the Wi-Fi device when the second determining subunit determines that the location corresponding to the first location information is outside the coverage of each of the Wi-Fi access points corresponding to each of all the Wi-Fi access point identifiers, and the location corresponding to the second location information is within the coverage of the at least one Wi-Fi access point among the Wi-Fi access points.

With reference to the second aspect and the first or the second possible implementation manner of the second aspect, in a third possible implementation manner, the control apparatus further includes an associative storage unit, where the acquiring unit is further configured to acquire a trigger instruction for connecting to a new Wi-Fi access point, where the trigger instruction carries an identifier of the new Wi-Fi access point, and acquire the identifier of the new Wi-Fi access point and coverage of the new Wi-Fi access point; and the associative storage unit is configured to associatively store the identifier of the new Wi-Fi access point and the coverage of the new Wi-Fi access point that are acquired by the acquiring unit.

With reference to the second aspect and the first to the third possible implementation manners of the second aspect, in a fourth possible implementation manner, the control apparatus further includes a first sending unit, where the first sending unit is configured to send a first search instruction to the Wi-Fi device after the second control unit triggers the turning-on of the Wi-Fi device, so that the Wi-Fi device searches for each of the Wi-Fi access points corresponding to each of all the Wi-Fi access point identifiers stored in the terminal, and the Wi-Fi device establishes a connection to one of found Wi-Fi access points.

With reference to the second aspect and the first to the third possible implementation manners of the second aspect, in a fifth possible implementation manner, the control apparatus further includes a second sending unit, a receiving unit, and a determining unit, where the second sending unit is configured to send a second search instruction to the Wi-Fi device, so that the Wi-Fi device searches for each of the Wi-Fi access points corresponding to each of all the Wi-Fi access point identifiers stored in the terminal; the receiving unit is configured to receive identifiers of found Wi-Fi access points sent by the Wi-Fi device; the determining unit is configured to determine an identifier of a Wi-Fi access point to which a connection is established for the most times among the identifiers of the found Wi-Fi access points received by the receiving unit; and the second sending unit is configured to send, to the Wi-Fi device, the identifier, which is determined by the determining unit, of the Wi-Fi access point to which the connection is established for the most times, so that the Wi-Fi device establishes a connection to the Wi-Fi access point corresponding to the identifier of the Wi-Fi access point to which the connection is established for the most times.

In a third aspect, the present invention provides a terminal, including a control apparatus and a Wi-Fi device, where the control apparatus controls the Wi-Fi device; and the control apparatus is the control apparatus described in the foregoing technical solutions.

In the embodiments of the present invention, first location information of the terminal at a first moment, second location information of the terminal at a second moment, and coverage of each of Wi-Fi access points corresponding to each of all Wi-Fi access point identifiers stored in the terminal are acquired, where the first moment is earlier than the second moment; turning-off of the Wi-Fi device is triggered when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment; and turning-on of the Wi-Fi device is triggered when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment. Compared with the prior art in which a Wi-Fi device in a standby state wastes power, and after the Wi-Fi device is turned off, the Wi-Fi device cannot be automatically turned on, with the control method for a Wi-Fi device in a terminal provided in the embodiments of the present invention, turning-off or turning-on of the Wi-Fi device in the terminal can be triggered according to a location of the terminal in a moving process, so that power of the terminal is saved, and furthermore, the Wi-Fi device does not need to be turned on manually by a user.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic diagram of an embodiment of a control method according to the embodiments of the present invention;

FIG. 2 is a schematic diagram of an embodiment of an application scenario according to the embodiments of the present invention;

FIG. 3 is a schematic diagram of an embodiment of a control apparatus according to the embodiments of the present invention;

FIG. 4 is a schematic diagram of another embodiment of the control apparatus according to the embodiments of the present invention;

FIG. 5 is a schematic diagram of another embodiment of the control apparatus according to the embodiments of the present invention;

FIG. 6 is a schematic diagram of another embodiment of the control apparatus according to the embodiments of the present invention;

FIG. 7 is a schematic diagram of another embodiment of the control apparatus according to the embodiments of the present invention;

FIG. 8 is a schematic diagram of another embodiment of the control apparatus according to the embodiments of the present invention;

FIG. 9 is a schematic diagram of an embodiment of a terminal according to the embodiments of the present invention;

FIG. 10 is a schematic diagram of another embodiment of the terminal according to the embodiments of the present invention;

FIG. 11 is a schematic diagram of another embodiment of the terminal according to the embodiments of the present invention; and

FIG. 12 is a schematic diagram of another embodiment of the terminal according to the embodiments of the present invention.

### DESCRIPTION OF EMBODIMENTS

Embodiments of the present invention provide a control method for a Wi-Fi device in a terminal, which can trigger turning-off or turning-on of the Wi-Fi device in the terminal according to location information of the terminal, so that power of the terminal is saved, and furthermore, the Wi-Fi device does not need to be turned on manually by a user. The embodiments of the present invention further provide a corresponding apparatus and terminal, which are described separately in detail in the following.

The following clearly describes the technical solutions in the embodiments of the present invention with reference to the accompanying drawings in the embodiments of the present invention. The embodiments to be described are merely a part rather than all of the embodiments of the present invention. All other embodiments obtained by a person of ordinary skill in the art based on the embodiments of the present invention without creative efforts shall fall within the protection scope of the present invention.

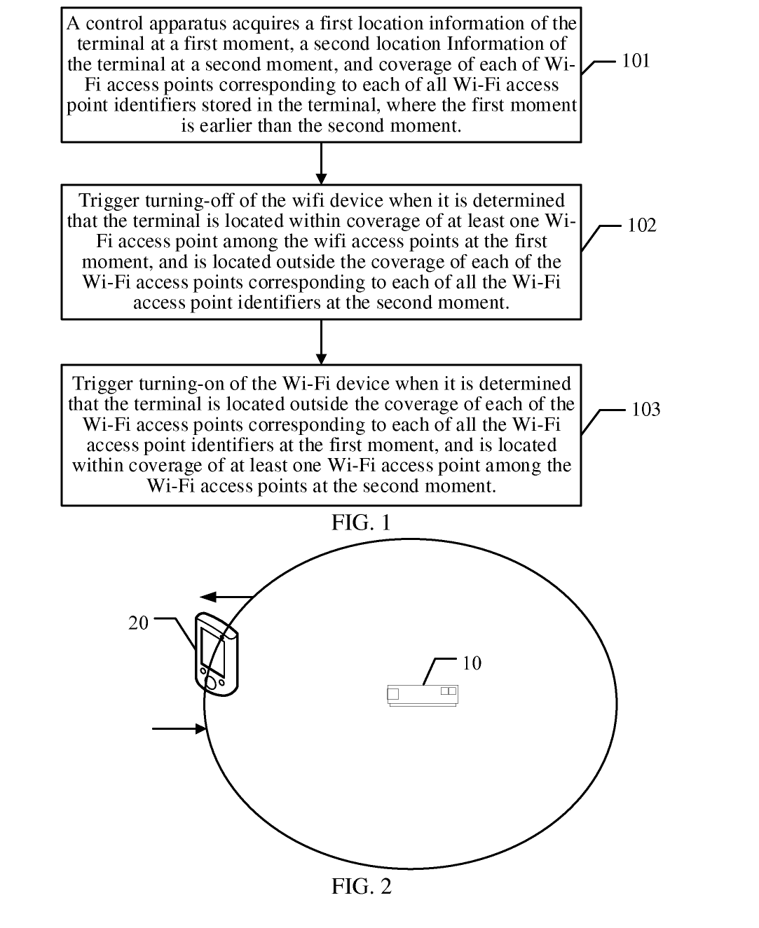

Referring to FIG. 1, an embodiment of a control method for a Wi-Fi device in a terminal provided in the embodiments of the present invention includes the following steps:

101: Acquire a first location information of the terminal at a first moment, a second location information of the terminal at a second moment, and coverage of each of Wi-Fi access points corresponding to each of all Wi-Fi access point identifiers stored in the terminal, where the first moment is earlier than the second moment.

For Wi-Fi, a network is connected through a radio wave, generally a wireless router is used, and a network can always be connected in a Wi-Fi connection manner within an effective area covered by a radio wave of the wireless router.

The Wi-Fi device is a Wi-Fi module in the terminal, where the Wi-Fi module establishes a connection to a Wi-Fi access point.

The Wi-Fi access point may be a terminal device such as a wireless router, and a computer or a mobile phone with a Wi-Fi function.

The terminal in the embodiment of the present invention may be a device such as a mobile phone, a personal digital assistant (PDA), and a notebook computer.

After establishing a connection to a Wi-Fi access point for the first time, the terminal stores an identifier of the Wi-Fi access point, such as an identifier of a wireless router.

Each Wi-Fi access point has coverage. Coverage of Wi-Fi access points corresponding to Wi-Fi access point identifiers stored in the terminal may all overlap, or partially overlap, or not overlap at all.

In a moving process, the terminal may move out of coverage of a Wi-Fi access point from the coverage of the Wi-Fi access point. If the terminal moves out of the coverage of the Wi-Fi access point, a Wi-Fi connection is disconnected, and if the Wi-Fi device is still in an on-state, power is consumed.

In the moving process of the terminal, location information of the terminal may be acquired continuously, where location information of a location where the terminal is located may be an identifier of a serving cell where the terminal is located, and preferably, is location information of accurate longitude and latitude obtained through positioning of a global positioning system (GPS).

Each Wi-Fi access point has a unique identifier, and coverage of a Wi-Fi access point may be set before the Wi-Fi access point leaves the factory, for example, an identifier of a wireless router corresponds to coverage of the wireless router.

102: Trigger turning-off of the Wi-Fi device when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment.

In the embodiment of the present invention, the determining whether the terminal is located within the coverage of each of the Wi-Fi access points corresponding to each of all the Wi-Fi access point identifiers at the first moment and whether the terminal is located within the coverage of each of the Wi-Fi access points corresponding to each of all the Wi-Fi access point identifiers at the second moment may be determining whether a location of the terminal at the first moment and a location of the terminal at the second moment are within or outside the coverage of each of the Wi-Fi access points corresponding to each of all the Wi-Fi access point identifiers.

For example, it is assumed that the terminal stores 5 Wi-Fi access point identifiers, which are Wi-Fi1, Wi-Fi2, Wi-Fi3, Wi-Fi4, and Wi-Fi5, and coverage of a Wi-Fi access point corresponding to each of the Wi-Fi access point identifiers has been determined. It is assumed that coverage of a Wi-Fi access point corresponding to Wi-Fi1 and coverage of a Wi-Fi access point corresponding to Wi-Fi2 partially overlap, and coverage of a Wi-Fi access point corresponding to each of Wi-Fi3, Wi-Fi4, and Wi-Fi5 does not overlap with coverage of the other 4 Wi-Fi access points, and when the terminal begins to move in the coverage of the Wi-Fi access point corresponding to Wi-Fi1, first location information at a first moment and second location information at a second moment are acquired. It is assumed that a location corresponding to the first location information is within the coverage of the Wi-Fi access point corresponding to Wi-Fi1, and if a location corresponding to the second location information is within the coverage of the Wi-Fi access point corresponding to Wi-Fi2, a handover between the Wi-Fi access points occurs; and if the location corresponding to the second location information is not within the coverage of the Wi-Fi access points corresponding to Wi-Fi1, Wi-Fi2, Wi-Fi3, Wi-Fi4, and Wi-Fi5, the turning-off of the Wi-Fi device can be triggered, so as to reduce power consumption of the Wi-Fi device.

103: Trigger turning-on of the Wi-Fi device when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment.

In the embodiment of the present invention, the determining whether the terminal is located within the coverage of each of the Wi-Fi access points corresponding to each of all the Wi-Fi access point identifiers at the first moment and whether the terminal is located within the coverage of each of the Wi-Fi access points corresponding to each of all the Wi-Fi access point identifiers at the second moment may be determining whether a location of the terminal at the first moment and a location of the terminal at the second moment are within or outside the coverage of each of the Wi-Fi access points corresponding to each of all the Wi-Fi access point identifiers.

For example, it is assumed that the terminal stores 5 Wi-Fi access point identifiers, which are Wi-Fi1, Wi-Fi2, Wi-Fi3, Wi-Fi4, and Wi-Fi5, and coverage of a Wi-Fi access point corresponding to each of the Wi-Fi access point identifiers has been determined. It is assumed that coverage of a Wi-Fi access point corresponding to Wi-Fi1 and coverage of a Wi-Fi access point corresponding to Wi-Fi2 partially overlap, and coverage of a Wi-Fi access point corresponding to each of Wi-Fi3, Wi-Fi4, and Wi-Fi5 does not overlap with coverage of the other 4 Wi-Fi access points, and when the terminal begins to move in the coverage of the Wi-Fi access point corresponding to Wi-Fi1, first location information at a first moment and second location information at a second moment are acquired. It is assumed that a location corresponding to the first location information is outside the coverage of the Wi-Fi access points corresponding to Wi-Fi1, Wi-Fi2, Wi-Fi3, Wi-Fi4, and Wi-Fi5, and a location corresponding to the second location information is within the coverage of the Wi-Fi access point corresponding to Wi-Fi1, and the turning-on of the Wi-Fi device can be triggered.

In the embodiment of the present invention, first location information of the terminal at a first moment, second location information of the terminal at a second moment, and coverage of each of Wi-Fi access points corresponding to each of all Wi-Fi access point identifiers stored in the terminal are acquired, where the first moment is earlier than the second moment; turning-off of the Wi-Fi device is triggered when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment; and turning-on of the Wi-Fi device is triggered when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment. Compared with the prior art in which a Wi-Fi device in a standby state wastes power, and after the Wi-Fi device is turned off, the Wi-Fi device cannot be automatically turned on, with the control method for a Wi-Fi device in a terminal provided in the embodiment of the present invention, turning-off or turning-on of the Wi-Fi device in the terminal can be triggered according to a location of the terminal in a moving process, so that power of the terminal is saved, and furthermore, the Wi-Fi device does not need to be turned on manually by a user.

Optionally, based on the embodiment corresponding to FIG. 1, in another embodiment of the control method for a Wi-Fi device in a terminal provided in the embodiments of the present invention, the step of triggering turning-off of the Wi-Fi device when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment may include determining a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and triggering the turning-off of the Wi-Fi device when the location corresponding to the first location information is within the coverage of the at least one Wi-Fi access point among the Wi-Fi access points, and the location corresponding to the second location information is outside the coverage of each of the Wi-Fi access points corresponding to each of all the Wi-Fi access point identifiers.

In the embodiment of the present invention, whether the location corresponding to the first location information of the terminal and the location corresponding to the second location information are within or outside the coverage of the Wi-Fi access points corresponding to the Wi-Fi access point identifiers stored in the terminal may be determined in a GPS positioning manner.

For example, if coverage of a Wi-Fi access point corresponding to a Wi-Fi access point identifier stored in the terminal is the Shenzhen International Trading Building, and it is acquired that in a moving process of the terminal, a location corresponding to first location information at a first moment is in the hall of the International Trading Building, and a location corresponding to second location information at a second moment is outside the entrance of the International Trading Building, it can be determined that the terminal has moved outside the coverage of the Wi-Fi access point, and turning-off of the Wi-Fi device can be triggered.

Optionally, based on the embodiment corresponding to FIG. 1, in another embodiment of the control method for a Wi-Fi device in a terminal provided in the embodiments of the present invention, the step of triggering turning-on of the Wi-Fi device when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment may include determining a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and triggering the turning-on of the Wi-Fi device when the location corresponding to the first location information is outside the coverage of each of the Wi-Fi access points corresponding to each of all the Wi-Fi access point identifiers, and the location corresponding to the second location information is within the coverage of the at least one Wi-Fi access point among the Wi-Fi access points.

In the embodiment of the present invention, if it is determined, through positioning of a GPS, that the location corresponding to the first location information of the terminal at the first moment is outside the entrance of the Shenzhen International Trading Building, and the location corresponding to the second location information at the second moment is the hall of the Shenzhen International Trading Building, it can be determined that the terminal enters the coverage of the Wi-Fi access point, and turning-on of the Wi-Fi device of the terminal can be triggered.

Optionally, based on the embodiment corresponding to FIG. 1 and an optional embodiment corresponding to FIG. 1, in another embodiment of the control method for a Wi-Fi device in a terminal provided in the embodiments of the present invention, the control method may further include acquiring a trigger instruction for connecting to a new Wi-Fi access point, where the trigger instruction carries an identifier of the new Wi-Fi access point; and acquiring and associatively storing the identifier of the new Wi-Fi access point and coverage of the new Wi-Fi access point.

In the embodiment of the present invention, after the terminal receives a trigger instruction triggered by a user for connecting to a new Wi-Fi access point, the terminal can acquire an identifier of the new Wi-Fi access point and coverage of the new Wi-Fi access point, and associatively store the identifier of the new Wi-Fi access point and the coverage of the new Wi-Fi access point.

Optionally, based on the embodiment corresponding to FIG. 1 and an optional embodiment corresponding to FIG. 1, in another embodiment of the control method for a Wi-Fi device in a terminal provided in the embodiments of the present invention, after the step of triggering turning on the Wi-Fi device, the control method may further include sending a first search instruction to the Wi-Fi device, so that the Wi-Fi device searches for each of the Wi-Fi access points corresponding to each of all the Wi-Fi access point identifiers stored in the terminal, and the Wi-Fi device establishes a connection to one of found Wi-Fi access points.

In the embodiment of the present invention, after the terminal enters coverage of a Wi-Fi access point, the Wi-Fi device is turned on, and after the Wi-Fi device is turned on, the Wi-Fi device can search for Wi-Fi access points corresponding to Wi-Fi access point identifiers stored in the terminal, where coverage of the Wi-Fi access points may overlap. When the Wi-Fi device finds only one Wi-Fi access point, the Wi-Fi device may establish a Wi-Fi connection to the found Wi-Fi access point. If the Wi-Fi device finds several Wi-Fi access points, the Wi-Fi device may establish a Wi-Fi connection to one selected found Wi-Fi access point.

Optionally, based on the embodiment corresponding to FIG. 1 and an optional embodiment corresponding to FIG. 1, in another embodiment of the control method for a Wi-Fi device in a terminal provided in the embodiments of the present invention, after the step of triggering turning on the Wi-Fi device, the control method may further include sending a second search instruction to the Wi-Fi device, so that the Wi-Fi device searches for each of the Wi-Fi access points corresponding to each of all the Wi-Fi access point identifiers stored in the terminal; receiving identifiers of found Wi-Fi access points sent by the Wi-Fi device; determining an identifier of a Wi-Fi access point to which a connection is established for the most times among the identifiers of the found Wi-Fi access points; and sending, to the Wi-Fi device, the identifier of the Wi-Fi access point to which the connection is established for the most times, so that the Wi-Fi device establishes a connection to the Wi-Fi access point corresponding to the identifier of the Wi-Fi access point to which the connection is established for the most times.

In the embodiment of the present invention, after the terminal enters coverage of a Wi-Fi access point, the Wi-Fi device is turned on, and after the Wi-Fi device is turned on, a control apparatus may send a search instruction to the Wi-Fi device, so that the Wi-Fi device can search for Wi-Fi access points corresponding to Wi-Fi access point identifiers stored in the terminal, where coverage of the Wi-Fi access points may overlap. When the Wi-Fi device finds only one or multiple Wi-Fi access points, the Wi-Fi device may return identifiers of the found Wi-Fi access points to the control apparatus, so that the control apparatus can determine an identifier of a Wi-Fi access point to which a connection is established for the most times, and instruct the Wi-Fi device to establish a connection to the Wi-Fi access point to which the connection is established for the most times.

For ease of understanding, a process of the control method for a Wi-Fi device in a terminal provided in the embodiments of the present invention is described in detail in the following using an application scenario as an example.

Referring to FIG. 2, coverage of a Wi-Fi access point 10 is determined, and a location where the Wi-Fi access point 10 is located may be used as the origin of coordinates, and the coverage of the Wi-Fi access point 10 is a circular area with a radius of 100 meters and centered on the origin of coordinates. A terminal 20 acquires, in a GPS or another manner, that first location information of the moving terminal 20 at a first moment is 90 meters to the left of the origin, and second location information of the moving terminal 20 at a second moment is 101 meters to the left of the origin, so that it can be determined that the terminal 20 moves outside the coverage of the Wi-Fi access point 10, and the terminal 20 can trigger turning-off of a Wi-Fi device in the terminal 20. If the terminal 20 acquires, in a GPS or another manner, that the first location information of the moving terminal 20 at the first moment is 101 meters to the left of the origin, and the second location information of the moving terminal 20 at the second moment is 90 meters to the left of the origin, it can be determined that the terminal 20 moves into the coverage of the Wi-Fi access point 10, and the terminal 20 can trigger turning-on of the Wi-Fi device in the terminal 20.

In this way, through the description of the foregoing application scenario, it can be clearly seen that, with the control method provided in the embodiments of the present invention, turning-off or turning-on of a Wi-Fi device in a terminal can be triggered according to location information of the terminal, so that power of the terminal is saved, and furthermore, the Wi-Fi device does not need to be turned on manually by a user.

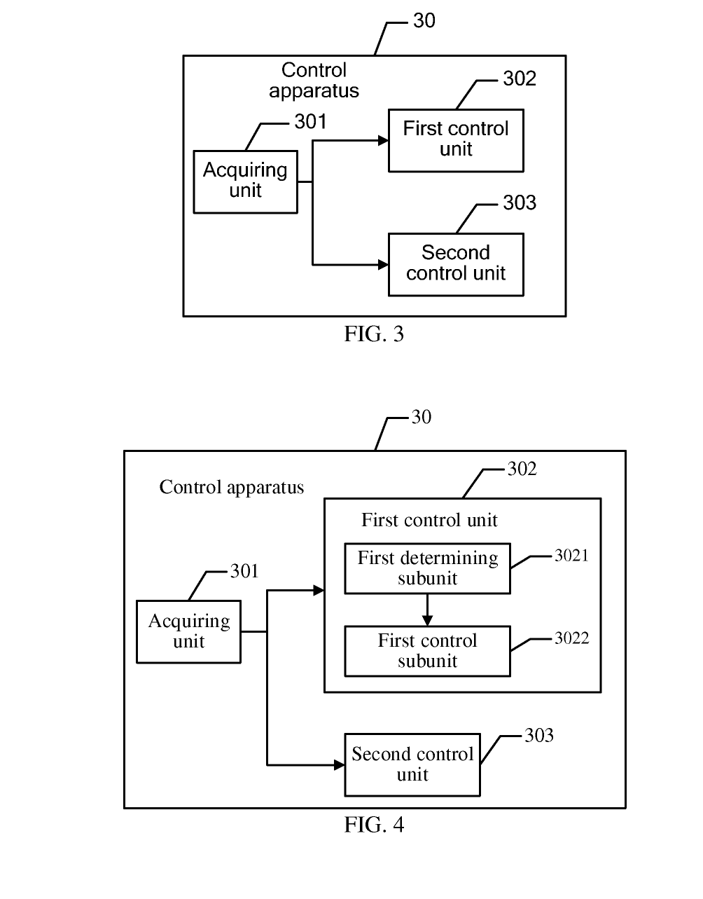

Referring to FIG. 3, an embodiment of a control apparatus 30 provided in the embodiments of the present invention includes an acquiring unit 301 configured to acquire first location information of a terminal at a first moment, second location information of the terminal at a second moment, and coverage of each of Wi-Fi access points corresponding to each of all Wi-Fi access point identifiers stored in the terminal, where the first moment is earlier than the second moment; a first control unit 302 configured to trigger turning-off of a Wi-Fi device when it is determined that the terminal is located within coverage, which is acquired by the acquiring unit 301, of at least one Wi-Fi access point among the Wi-Fi access points at the first moment, and is located outside the coverage of each of the Wi-Fi access points corresponding to each of all the Wi-Fi access point identifiers at the second moment; and a second control unit 303 configured to trigger turning-on of the Wi-Fi device when it is determined that the terminal is located outside the coverage, which is acquired by the acquiring unit 301, of each of the Wi-Fi access points corresponding to each of all the Wi-Fi access point identifiers at the first moment, and is located within coverage of at least one Wi-Fi access point among the Wi-Fi access points at the second moment.

In the embodiment of the present invention, the acquiring unit 301 acquires first location information of the terminal at a first moment, second location information of the terminal at a second moment, and coverage of each of Wi-Fi access points corresponding to each of all Wi-Fi access point identifiers stored in the terminal, where the first moment is earlier than the second moment; the first control unit 302 triggers turning-off of the Wi-Fi device when it is determined that the terminal is located within coverage, which is acquired by the acquiring unit 301, of at least one Wi-Fi access point among the Wi-Fi access points at the first moment, and is located outside the coverage of each of the Wi-Fi access points corresponding to each of all the Wi-Fi access point identifiers at the second moment; and the second control unit 303 triggers turning-on of the Wi-Fi device when it is determined that the terminal is located outside the coverage, which is acquired by the acquiring unit 301, of each of the Wi-Fi access points corresponding to each of all the Wi-Fi access point identifiers at the first moment, and is located within coverage of at least one Wi-Fi access point among the Wi-Fi access points at the second moment. Compared with the prior art, the control apparatus provided in the embodiments of the present invention can trigger turning-off or turning-on of a Wi-Fi device in a terminal according to location information of the terminal, so that power of the terminal is saved, and furthermore, the Wi-Fi device does not need to be turned on manually by a user.

Based on the embodiment corresponding to FIG. 3, referring to FIG. 4, in another embodiment of the control apparatus 30 provided in the embodiments of the present invention, the first control unit 302 includes a first determining subunit 3021 and a first control subunit 3022, where the first determining subunit 3021 is configured to determine a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and the first control subunit 3022 is configured to trigger the turning-off of the Wi-Fi device when the first determining subunit 3021 determines that the location corresponding to the first location information is within the coverage of the at least one Wi-Fi access point among the Wi-Fi access points, and the location corresponding to the second location information is outside the coverage of each of the Wi-Fi access points corresponding to each of all the Wi-Fi access point identifiers.

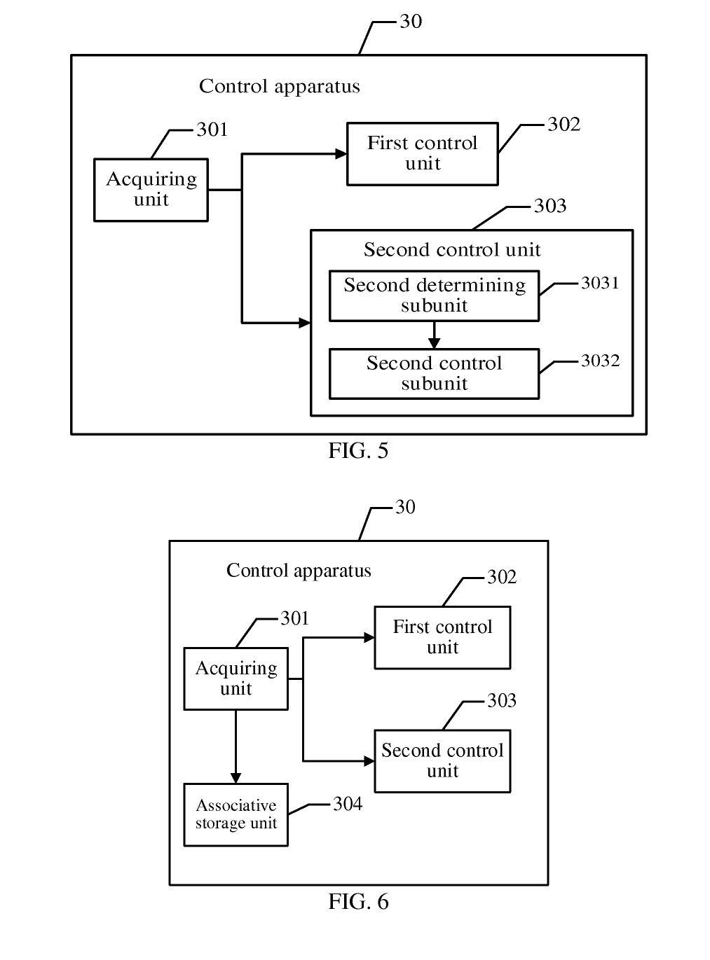

Based on the embodiment corresponding to FIG. 3, referring to FIG. 5, in another embodiment of the control apparatus 30 provided in the embodiments of the present invention, the second control unit 303 includes a second determining subunit 3031 and a second control subunit 3032, where the second determining subunit 3031 is configured to determine a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and the second control subunit 3032 is configured to trigger the turning-on of the Wi-Fi device when the second determining subunit 3031 determines that the location corresponding to the first location information is outside the coverage of each of the Wi-Fi access points corresponding to each of all the Wi-Fi access point identifiers, and the location corresponding to the second location information is within the coverage of the at least one Wi-Fi access point among the Wi-Fi access points.

Based on the embodiment corresponding to FIG. 3, referring to FIG. 6, another embodiment of the control apparatus 30 provided in the embodiments of the present invention further includes an associative storage unit 304, where the acquiring unit 301 is further configured to acquire a trigger instruction for connecting to a new Wi-Fi access point, where the trigger instruction carries an identifier of the new Wi-Fi access point, and acquire the identifier of the new Wi-Fi access point and coverage of the new Wi-Fi access point; and the associative storage unit 304 is configured to associatively store the identifier of the new Wi-Fi access point and the coverage of the new Wi-Fi access point that are acquired by the acquiring unit 301.

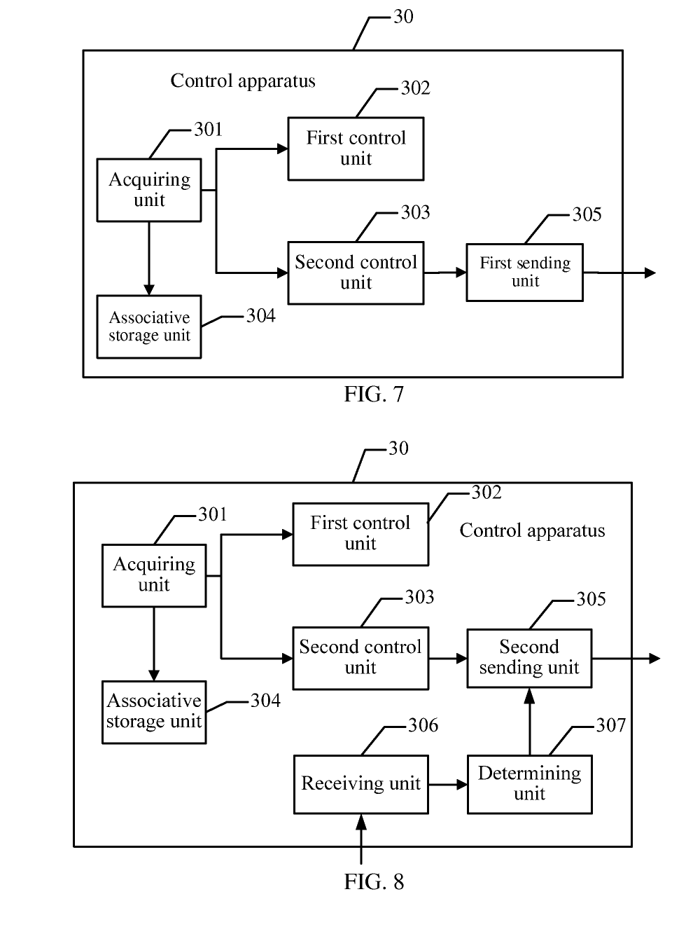

Based on the embodiment corresponding to FIG. 6, referring to FIG. 7, another embodiment of the control apparatus 30 provided in the embodiments of the present invention further includes a first sending unit 305, where the first sending unit 305 is configured to send a first search instruction to the Wi-Fi device after the second control unit 303 triggers the turning-on of the Wi-Fi device, so that the Wi-Fi device searches for each of the Wi-Fi access points corresponding to each of all the Wi-Fi access point identifiers stored in the terminal, and the Wi-Fi device establishes a connection to one of found Wi-Fi access points.

Based on the embodiment corresponding to FIG. 6, referring to FIG. 8, another embodiment of the control apparatus 30 provided in the embodiments of the present invention further includes a second sending unit 305, a receiving unit 306, and a determining unit 307, where the second sending unit 305 is configured to send a second search instruction to the Wi-Fi device after the second control unit 303 triggers the turning-on of the Wi-Fi device, so that the Wi-Fi device searches for each of the Wi-Fi access points corresponding to each of all the Wi-Fi access point identifiers stored in the terminal; the receiving unit 306 is configured to receive identifiers of found Wi-Fi access points sent by the Wi-Fi device; the determining unit 307 is configured to determine an identifier of a Wi-Fi access point to which a connection is established for the most times among the identifiers of the found Wi-Fi access points received by the receiving unit 306; and the second sending unit 305 is further configured to send, to the Wi-Fi device, the identifier, which is determined by the determining unit 307, of the Wi-Fi access point to which the connection is established for the most times, so that the Wi-Fi device establishes a connection to the Wi-Fi access point corresponding to the identifier of the Wi-Fi access point to which the connection is established for the most times.

An embodiment of the present invention further provides a computer readable storage medium, where the computer readable storage medium stores an executable program, and when the program is run, the following steps are performed: acquiring first location information of a terminal at a first moment, second location information of the terminal at a second moment, and coverage of each of Wi-Fi access points corresponding to each of all Wi-Fi access point identifiers stored in the terminal, where the first moment is earlier than the second moment; triggering turning-off of a Wi-Fi device when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment; and triggering turning-on of the Wi-Fi device when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment.

When the program is run, the following steps may further be performed: acquiring a trigger instruction for connecting to a new Wi-Fi access point, where the trigger instruction carries an identifier of the new Wi-Fi access point; and acquiring and associatively storing the identifier of the new Wi-Fi access point and coverage of the new Wi-Fi access point.

When the program is run, the following step may further be performed: sending a first search instruction to the Wi-Fi device, so that the Wi-Fi device searches for each of the Wi-Fi access points corresponding to each of all the Wi-Fi access point identifiers stored in the terminal, and the Wi-Fi device establishes a connection to one of found Wi-Fi access points.

When the program is run, the following steps may further be performed: sending a second search instruction to the Wi-Fi device, so that the Wi-Fi device searches for each of the Wi-Fi access points corresponding to each of all the Wi-Fi access point identifiers stored in the terminal; receiving identifiers of found Wi-Fi access points sent by the Wi-Fi device; determining an identifier of a Wi-Fi access point to which a connection is established for the most times among the identifiers of the found Wi-Fi access points; and sending, to the Wi-Fi device, the identifier of the Wi-Fi access point to which the connection is established for the most times, so that the Wi-Fi device establishes a connection to the Wi-Fi access point corresponding to the identifier of the Wi-Fi access point to which the connection is established for the most times.

Referring to FIG. 9, an embodiment of a terminal 20 provided in the embodiments of the present invention includes a Wi-Fi device 200, a detection apparatus 210, a memory 220, and a processor 230, where the detection apparatus 210 is configured to detect, in a moving process of the terminal, first location information at a first moment and second location information at a second moment; the memory 220 is configured to store coverage of each of Wi-Fi access points corresponding to each of all Wi-Fi access point identifiers, where all Wi-Fi access points have established a connection to the terminal before; and the processor 230 is configured to trigger turning-off of the Wi-Fi device 200 when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment; and trigger turning-on of the Wi-Fi device 200 when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment.

Based on the embodiment corresponding to FIG. 9, in another embodiment of the terminal 20 provided in the embodiments of the present invention, the processor 230 is configured to determine a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and trigger the turning-off of the Wi-Fi device 200 when the location corresponding to the first location information is within the coverage of the at least one Wi-Fi access point among the Wi-Fi access points, and the location corresponding to the second location information is outside the coverage of each of the Wi-Fi access points corresponding to each of all the Wi-Fi access point identifiers.

Based on the embodiment corresponding to FIG. 9, in another embodiment of the terminal provided in the embodiments of the present invention, the processor 230 is configured to determine a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers; and trigger the turning-on of the Wi-Fi device 200 when it is determined that the location corresponding to the first location information is outside the coverage of each of the Wi-Fi access points corresponding to each of all the Wi-Fi access point identifiers, and the location corresponding to the second location information is within the coverage of the at least one Wi-Fi access point among the Wi-Fi access points.

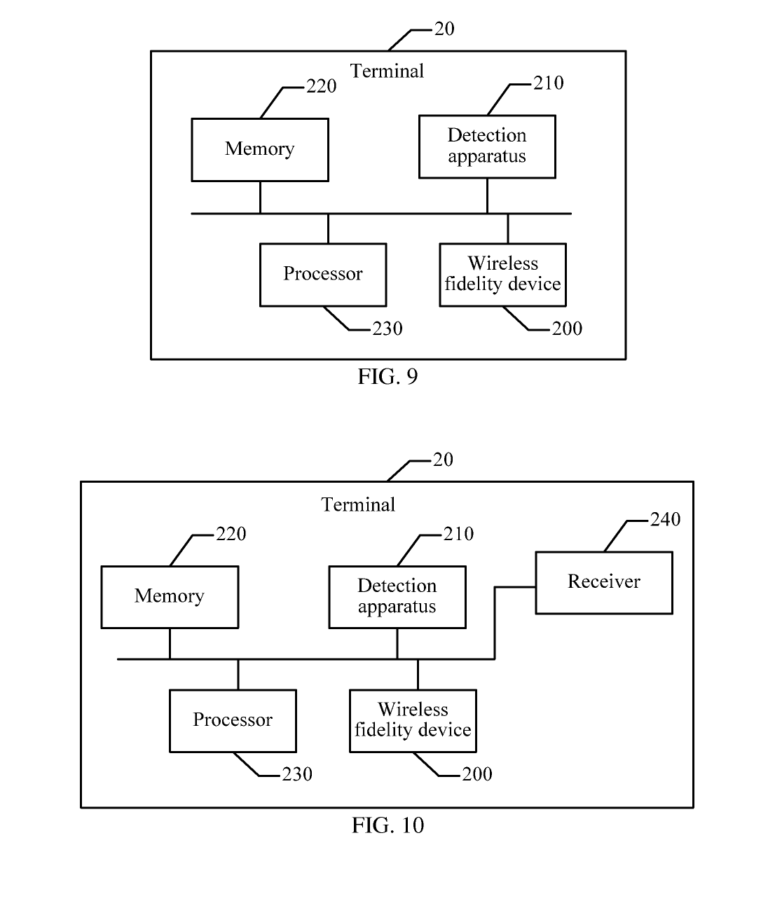

Based on the embodiment corresponding to FIG. 9, referring to FIG. 10, another embodiment of the terminal provided in the embodiments of the present invention further includes a receiver 240, where the receiver 240 is configured to receive a trigger instruction for connecting to a new Wi-Fi access point, where the trigger instruction carries an identifier of the new Wi-Fi access point; the detection apparatus 210 is further configured to detect coverage of the new Wi-Fi access point corresponding to the identifier of the new Wi-Fi access point; and the memory 220 is further configured to associatively store the identifier of the new Wi-Fi access point and the coverage of the new Wi-Fi access point.

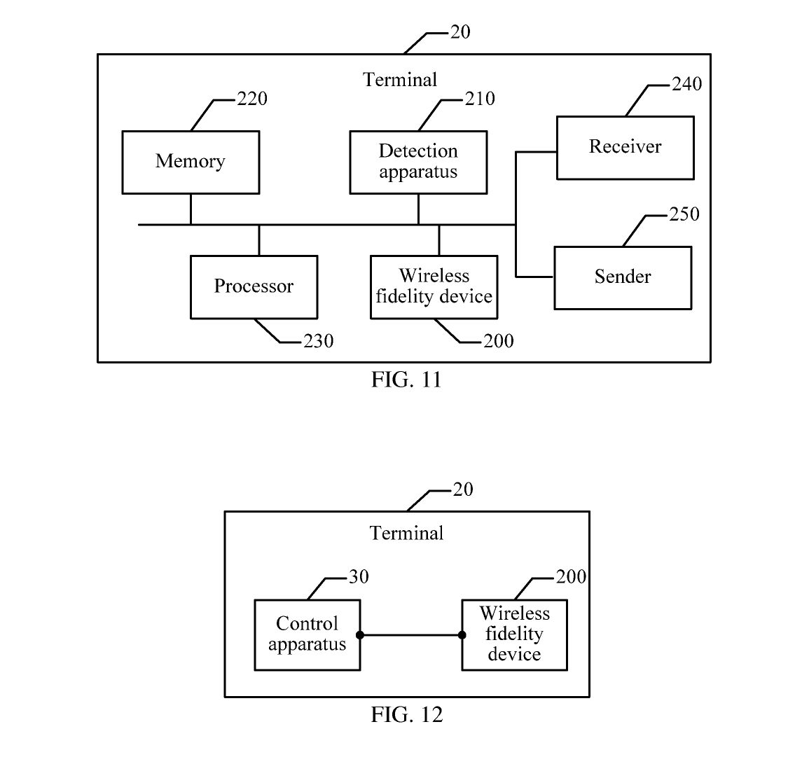

Based on the embodiment corresponding to FIG. 10, referring to FIG. 11, another embodiment of the terminal 20 provided in the embodiments of the present invention further includes a sender 250, where the sender 250 is configured to send a first search instruction to the Wi-Fi device 200, so that the Wi-Fi device searches for each of the Wi-Fi access points corresponding to each of all the Wi-Fi access point identifiers stored in the terminal, and the Wi-Fi device establishes a connection to one of found Wi-Fi access points.

Referring to FIG. 11, in another embodiment of the terminal 20 provided in the embodiments of the present invention, the sender 250 is further configured to send a second search instruction to the Wi-Fi device 200, so that the Wi-Fi device searches for each of the Wi-Fi access points corresponding to each of all the Wi-Fi access point identifiers stored in the terminal; the receiver 240 is further configured to receive identifiers of found Wi-Fi access points sent by the Wi-Fi device 200; the processor 230 is further configured to determine an identifier of a Wi-Fi access point to which a connection is established for the most times among the identifiers of the found Wi-Fi access points; and the sender 250 is further configured to send, to the Wi-Fi device 200, the identifier of the Wi-Fi access point to which the connection is established for the most times, so that the Wi-Fi device establishes a connection to the Wi-Fi access point corresponding to the identifier of the Wi-Fi access point to which the connection is established for the most times.

Referring to FIG. 12, another embodiment of the terminal 20 provided in the embodiments of the present invention includes a control apparatus 30 and a Wi-Fi device 200, where the control apparatus 30 controls the Wi-Fi device 200; and the control apparatus 30 is configured to acquire first location information of the terminal at a first moment, second location information of the terminal at a second moment, and coverage of each of Wi-Fi access points corresponding to each of all Wi-Fi access point identifiers stored in the terminal, where the first moment is earlier than the second moment; trigger turning-off of the Wi-Fi device when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment; and trigger turning-on of the Wi-Fi device when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment.

The terminal provided in the embodiments of the present invention can trigger turning-off or turning-on of a Wi-Fi device in a terminal according to location information of the terminal, so that power of the terminal is saved, and furthermore, the Wi-Fi device does not need to be turned on manually by a user.

A person of ordinary skill in the art may understand that all or part of the steps of the methods in the foregoing embodiments may be implemented by a program instructing relevant hardware. The program may be stored in a computer readable storage medium. The storage medium may include a read-only memory (ROM), a random access memory (RAM), a magnetic disk, or an optical disc, or the like.

The control method and apparatus for a Wi-Fi device in a terminal, and the terminal provided in the embodiments of the present invention are described in the foregoing in detail. Although the principles and implementation manners of the present invention are described through specific examples in this specification, the descriptions of the foregoing embodiments are only intended to help understand the method and core ideas of the present invention. Meanwhile, a person of ordinary skill in the art may make modifications to the specific implementation manners and application scopes according to the ideas of the present invention. In conclusion, the content of the specification shall not be construed as a limitation to the present invention.

What is claimed is:

1. A control method for a wireless fidelity (Wi-Fi) device in a terminal comprising:
acquiring first location information of the terminal at a first moment, second location information of the terminal at a second moment, and coverage of each of Wi-Fi access points corresponding to each of all Wi-Fi access point identifiers stored in the terminal, wherein the first moment is earlier than the second moment;
triggering turning-off of the Wi-Fi device when it is determined that the terminal is located within coverage of at least one Wi-Fi access point among the Wi-Fi access points at the first moment and is located outside the coverage of each of the Wi-Fi access points corresponding to each of all the Wi-Fi access point identifiers at the second moment; and
triggering turning-on of the Wi-Fi device when it is determined that the terminal is located outside the coverage of each of the Wi-Fi access points corresponding to each of all the Wi-Fi access point identifiers at the first moment and is located within coverage of at least one Wi-Fi access point among the Wi-Fi access points at the second moment.

2. The control method according to claim 1, wherein triggering turning-off of the Wi-Fi device when it is determined that the terminal is located within coverage of at least one Wi-Fi access point among the Wi-Fi access points at the first moment and is located outside the coverage of each of the Wi-Fi access points corresponding to each of all the Wi-Fi access point identifiers at the second moment further comprises:
determining a relationship between a location corresponding to the first location information and the coverage of each of the Wi-Fi access points corresponding to each of all the Wi-Fi access point identifiers;
determining a relationship between a location corresponding to the second location information and the coverage of each of the Wi-Fi access points corresponding to each of all the Wi-Fi access point identifiers; and
triggering the turning-off of the Wi-Fi device when the location corresponding to the first location information is within the coverage of the at least one Wi-Fi access point among the Wi-Fi access points, and the location corresponding to the second location information is outside the coverage of each of the Wi-Fi access points corresponding to each of all the Wi-Fi access point identifiers.

3. The control method according to claim 1, wherein triggering turning-on of the Wi-Fi device when it is determined that the terminal is located outside the coverage of each of the Wi-Fi access points corresponding to each of all the Wi-Fi access point identifiers at the first moment and is located within coverage of at least one Wi-Fi access point among the Wi-Fi access points at the second moment further comprises:
determining a relationship between a location corresponding to the first location information and the coverage of each of the Wi-Fi access points corresponding to each of all the Wi-Fi access point identifiers;
determining a relationship between a location corresponding to the second location information and the coverage of each of the Wi-Fi access points corresponding to each of all the Wi-Fi access point identifiers; and
triggering the turning-on of the Wi-Fi device when the location corresponding to the first location information is outside the coverage of each of the Wi-Fi access points corresponding to each of all the Wi-Fi access point identifiers, and wherein the location corresponding to the second location information is within the coverage of the at least one Wi-Fi access point among the Wi-Fi access points.

4. The control method according to claim 1, further comprising:
acquiring a trigger instruction for connecting to a new Wi-Fi access point, wherein the trigger instruction carries an identifier of the new Wi-Fi access point; and
acquiring and associatively storing the identifier of the new Wi-Fi access point and coverage of the new Wi-Fi access point.

5. The control method according to claim 1, wherein, after triggering turning on the Wi-Fi device, the method further comprises:
sending a first search instruction to the Wi-Fi device, so that the Wi-Fi device searches for each of the Wi-Fi access points corresponding to each of all the Wi-Fi access point identifiers stored in the terminal, wherein the Wi-Fi device establishes a connection to one of found Wi-Fi access points.

6. The control method according to claim 1, wherein after the step of triggering turning on the Wi-Fi device, the method further comprises:
sending a second search instruction to the Wi-Fi device, so that the Wi-Fi device searches for each of the Wi-Fi access points corresponding to each of all the Wi-Fi access point identifiers stored in the terminal;
receiving identifiers of found Wi-Fi access points sent by the Wi-Fi device;
determining an identifier of a Wi-Fi access point to which a connection is established for the most times among the identifiers of the found Wi-Fi access points; and
sending, to the Wi-Fi device, the identifier of the Wi-Fi access point to which the connection is established for the most times, so that the Wi-Fi device establishes a connection to the Wi-Fi access point corresponding to the identifier of the Wi-Fi access point to which the connection is established for the most times.

7. A control apparatus comprising:
an acquiring unit configured to acquire first location information of a terminal at a first moment, second location information of the terminal at a second moment, and coverage of each of Wi-Fi access points corresponding to each of all Wi-Fi access point identifiers stored in the terminal, wherein the first moment is earlier than the second moment;
a first control unit configured to trigger turning-off of a Wi-Fi device when it is determined that the terminal is located within coverage, which is acquired by the acquiring unit, of at least one Wi-Fi access point among the Wi-Fi access points at the first moment and is located outside the coverage of each of the Wi-Fi access points corresponding to each of all the Wi-Fi access point identifiers at the second moment; and
a second control unit configured to trigger turning-on of the Wi-Fi device when it is determined that the terminal is located outside the coverage, which is acquired by the acquiring unit, of each of the Wi-Fi access points corresponding to each of all the Wi-Fi access point identifiers at the first moment, and is located within coverage of at least one Wi-Fi access point among the Wi-Fi access points at the second moment.

8. The control apparatus according to claim 7, wherein the first control unit comprises:
a first determining subunit; and
a first control subunit, wherein the first determining subunit is configured to determine a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers, and wherein the first control subunit is configured to trigger turning-off of the Wi-Fi device when the first determining subunit determines that the location corresponding to the first location information is within the coverage of the at least one Wi-Fi access point among the Wi-Fi access points, and wherein the location corresponding to the second location information is outside the coverage of each of the Wi-Fi access points corresponding to each of all the Wi-Fi access point identifiers.

9. The control apparatus according to claim 7, wherein the second control unit comprises:
a second determining subunit; and
a second control subunit, wherein the second determining subunit is configured to determine a relationship between a location corresponding to the first location information and the coverage of each of the Wi-Fi access points corresponding to each of all the Wi-Fi access point identifiers, and a relationship between a location corresponding to the second location information and the coverage of each of the Wi-Fi access points corresponding to each of all the Wi-Fi access point identifiers, and wherein the second control subunit is configured to trigger the turning-on of the Wi-Fi device when the second determining subunit determines that the location corresponding to the first location information is outside the coverage of each of the Wi-Fi access points corresponding to each of all the Wi-Fi access point identifiers, and wherein the location corresponding to the second location information is within the coverage of the at least one Wi-Fi access point among the Wi-Fi access points.

10. The control apparatus according to claim 7, further comprising an associative storage unit, wherein the acquiring unit is further configured to:
acquire a trigger instruction for connecting to a new Wi-Fi access point, wherein the trigger instruction carries an identifier of the new Wi-Fi access point; and
acquire the identifier of the new Wi-Fi access point and coverage of the new Wi-Fi access point, and wherein the associative storage unit is configured to associatively store the identifier of the new Wi-Fi access point and the coverage of the new Wi-Fi access point that are acquired by the acquiring unit.

11. The control apparatus according to claim 7, further comprising a first sending unit, wherein the first sending unit is configured to send a first search instruction to the Wi-Fi device after the second control unit triggers the turning-on of the Wi-Fi device, so that the Wi-Fi device searches for each of the Wi-Fi access points corresponding to each of all the Wi-Fi access point identifiers stored in the terminal, and wherein the Wi-Fi device establishes a connection to one of found Wi-Fi access points.

12. The control apparatus according to claim 7, further comprising:
a second sending unit;
a receiving unit; and
a determining unit, wherein the second sending unit is configured to send a second search instruction to the Wi-Fi device, so that the Wi-Fi device searches for each of the Wi-Fi access points corresponding to each of all the Wi-Fi access point identifiers stored in the terminal, wherein the receiving unit is configured to receive identifiers of found Wi-Fi access points sent by the Wi-Fi device, wherein the determining unit is configured to determine an identifier of a Wi-Fi access point to which a connection is established for the most times among the identifiers of the found Wi-Fi access points received by the receiving unit, and wherein the second sending unit is configured to send, to the Wi-Fi device, the identifier, which is determined by the determining unit, of the Wi-Fi access point to which the connection is established for the most times, so that the Wi-Fi device establishes a connection to the Wi-Fi access point corresponding to the identifier of the Wi-Fi access point to which the connection is established for the most times.

13. A computer readable storage medium having a program recorded thereon, wherein the program makes the computer execute the following method:
acquiring first location information of the terminal at a first moment, second location information of the terminal at a second moment, and coverage of each of Wi-Fi access points corresponding to each of all Wi-Fi access point identifiers stored in the terminal, wherein the first moment is earlier than the second moment;
triggering turning-off of the Wi-Fi device when it is determined that the terminal is located within coverage of at least one Wi-Fi access point among the Wi-Fi access points at the first moment and is located outside the coverage of each of the Wi-Fi access points corresponding to each of all the Wi-Fi access point identifiers at the second moment; and
triggering turning-on of the Wi-Fi device when it is determined that the terminal is located outside the coverage of each of the Wi-Fi access points corresponding to each of all the Wi-Fi access point identifiers at the first moment and is located within coverage of at least one Wi-Fi access point among the Wi-Fi access points at the second moment.

14. A terminal comprising:
a Wi-Fi device;
a detection apparatus;
a memory; and
a processor, wherein the detection apparatus is configured to detect first location information at a first moment and second location information at a second moment, wherein the memory is configured to store coverage of each of Wi-Fi access points corresponding to each of all Wi-Fi access point identifiers, wherein the all Wi-Fi access points have established a connection to the terminal before, and wherein the processor is configured to:
trigger turning-off of the Wi-Fi device when it is determined that the terminal is located within coverage of at least one Wi-Fi access point among the Wi-Fi access points at the first moment, and is located outside the coverage of each of the Wi-Fi access points corresponding to each of all the Wi-Fi access point identifiers at the second moment; and
trigger turning-on of the Wi-Fi device when it is determined that the terminal is located outside the coverage of each of the Wi-Fi access points corresponding to each of all the Wi-Fi access point identifiers at the first moment, and is located within coverage of at least one Wi-Fi access point among the Wi-Fi access points at the second moment.

15. The terminal according to claim 14, wherein the processor is further configured to:
determine a relationship between a location corresponding to the first location information and the coverage of each of the Wi-Fi access points corresponding to each of all the Wi-Fi access point identifiers;
determine a relationship between a location corresponding to the second location information and the coverage of each of the Wi-Fi access points corresponding to each of all the Wi-Fi access point identifiers; and
trigger the turning-off of the Wi-Fi device when the location corresponding to the first location information is within the coverage of the at least one Wi-Fi access point among the Wi-Fi access points, and wherein the location corresponding to the second location information is outside the coverage of each of the Wi-Fi access points corresponding to each of all the Wi-Fi access point identifiers.

16. The terminal according to claim 14, wherein the processor is further configured to:
determine a relationship between a location corresponding to the first location information and the coverage of each of the Wi-Fi access points corresponding to each of all the Wi-Fi access point identifiers;
determine a relationship between a location corresponding to the second location information and the coverage of each of the Wi-Fi access points corresponding to each of all the Wi-Fi access point identifiers; and
trigger the turning-on of the Wi-Fi device when it is determined that the location corresponding to the first location information is outside the coverage of each of the Wi-Fi access points corresponding to each of all the Wi-Fi access point identifiers, and wherein the location corresponding to the second location information is within the coverage of the at least one Wi-Fi access point among the Wi-Fi access points.

17. The terminal according to claim 14, further comprising a receiver, wherein the receiver is configured to receive a trigger instruction for connecting to a new Wi-Fi access point, wherein the trigger instruction carries an identifier of the new Wi-Fi access point, wherein the detection apparatus is further configured to detect coverage of the new Wi-Fi access point corresponding to the identifier of the new Wi-Fi access point, and wherein the memory is further configured to associatively store the identifier of the new Wi-Fi access point and the coverage of the new Wi-Fi access point.

18. The terminal according to claim 17, further comprising a sender, wherein the sender is configured to send a first search instruction to the Wi-Fi device after the processor triggers the turning-on of the Wi-Fi device, so that the Wi-Fi device searches for each of the Wi-Fi access points corresponding to each of all the Wi-Fi access point identifiers stored in the terminal, and the Wi-Fi device establishes a connection to one of found Wi-Fi access points.

19. The terminal according to claim 18, wherein the sender is further configured to send a second search instruction to the Wi-Fi device, so that the Wi-Fi device searches for each of the Wi-Fi access points corresponding to each of all the Wi-Fi access point identifiers stored in the terminal, wherein the receiver is further configured to receive identifiers of found Wi-Fi access points sent by the Wi-Fi device, wherein the processor is further configured to determine an identifier of a Wi-Fi access point to which a connection is established for the most times among the identifiers of the found Wi-Fi access points, and wherein the sender is further configured to send, to the Wi-Fi device, the identifier of the Wi-Fi access point to which the connection is established for the most times, so that the Wi-Fi device establishes a connection to the Wi-Fi access point corresponding to the identifier of the Wi-Fi access point to which the connection is established for the most times.
